(19) United States
(12) Patent Application Publication
(10) Pub. No.: US 2014/0362118 A1
(43) Pub. Date: Dec. 11, 2014

(54) Method and System for Displaying Imagery as a Wallpaper on a Computing Device

(71) Applicants: Owen Brydon, Mountain View, CA (US); Marco Zennaro, San Francisco, SC (US); Jeremiah Childs, Berkeley, CA (US); Kyle Kakligian, Oakland, CA (US)

(72) Inventors: Owen Brydon, Mountain View, CA (US); Marco Zennaro, San Francisco, SC (US); Jeremiah Childs, Berkeley, CA (US); Kyle Kakligian, Oakland, CA (US)

(73) Assignee: GOOGLE INC., Mountain View, CA (US)

(21) Appl. No.: 13/314,275

(22) Filed: Dec. 8, 2011

(51) Int. Cl. G09G 5/373; G09G 5/00

(52) U.S. Cl. 345/660; 345/619

(57) ABSTRACT

A live wallpaper for a computing device is disclosed. The live wallpaper displays imagery from various image sources (e.g. Picasaweb, Panoramio, Google+, Facebook, Twitter) and displays new imagery upon the occurrence of various trigger conditions, such as upon user interaction with the live wallpaper or upon the passage of a period of time. In a particular implementation, the live wallpaper can be configured to display geolocated photographs associated with a geographic area input into the computing device. For instance, geolocated photographs associated with a user's current location can be displayed and can change automatically as the user's locality changes. The live wallpaper can be configured to display imagery that has not previously been displayed as the wallpaper on the computing device to present new and unseen images and different backgrounds for the computing device.

### FIELD

The present disclosure relates to background desktop components commonly referred to as computer wallpaper.

### BACKGROUND

Computing devices, including mobile devices such as smartphones, PDAs, and tablets, often include an operating system that includes a graphical user interface that allows users to interact with components of the operating system in a more intuitive manner. A typical graphical user interface includes a home screen having a background which extends across substantially all of the display. The background can be a plain color or can include an image in the form of a wallpaper to better beautify the home screen. Icons associated with various applications can be shown on a visual layer in front of the background/wallpaper. The icons can be moved independently of the wallpaper and are displayed by the computing device visually on top of the wallpaper. A user can open a particular application by interacting with the icons displayed on top of the wallpaper. Open applications can be shown on a visual layer even further in front of the layer for icons.

Users traditionally have been allowed to select particular images for their wallpaper so as to better customize the computing devices to their tastes. For instance, a user can select a particular photograph or image to serve as the wallpaper for the computing device. Active or live wallpapers that display different images in response to input from a user or in response to information received from another computing device are also known. These active wallpapers can display, for instance, real time data downloaded from a remote server, such as a map with travel directions, weather information, or data received from a social networking site.

### SUMMARY

Aspects and advantages of the invention will be set forth in part in the following description, or may be obvious from the description, or may be learned through practice of the invention.

One exemplary aspect of the present disclosure is directed to a computer-implemented method for presenting a wallpaper on a computing device. The method includes presenting a wallpaper on a display of a computing device. The wallpaper displays an image downloaded from an image source. The image is associated with a geographic area input into the computing device. The method includes receiving a trigger condition at the computing device. Upon the occurrence of the trigger condition, the method includes determining whether any unseen images associated with the geographic area are available for display from the image source; downloading an unseen image from the image source to a memory at the computing device; and updating the wallpaper to display a different image on the display of the computing device.

Another exemplary aspect of the present disclosure is directed a computing device having an application for presenting imagery as a wallpaper on a display of the computing device. The computing device includes an image downloader configured to download an image from an image source upon the occurrence of a trigger condition at the computing device. The computing device further includes a first memory location configured to store images downloaded by the image downloader and a second memory location configured to store data associated with images downloaded for display as the graphical wallpaper on the display device. Upon occurrence of the trigger condition, the computing device replaces imagery displayed as the wallpaper on the display device with a downloaded image stored in the first memory location, and simultaneously queries an image source for a new image for downloading to the computing device.

Other exemplary implementations of the present disclosure are directed to systems, apparatus, computer-readable media, devices, and user interfaces for presenting imagery as a wallpaper on the display of a computing device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary computing device having a display that includes a graphical wallpaper;

FIG. 2 depicts a conceptual side diagram of the display shown on the device of FIG. 1;

FIG. 3 depicts an exemplary computing device with a graphical wallpaper according to an exemplary embodiment of the present disclosure;

FIG. 4 depicts an exemplary computing device with a graphical wallpaper according to an exemplary embodiment of the present disclosure;

FIG. 5 depicts an exemplary computing device with a graphical wallpaper according to an exemplary embodiment of the present disclosure;

FIG. 6 depicts a block diagram of an exemplary computing device configured to present a graphical wallpaper according to an exemplary embodiment of the present disclosure; and

FIG. 7 depicts a flow diagram of an exemplary method for presenting a graphical wallpaper on the display of a computing device according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a live wallpaper for a computing device, such as a smartphone, PDA, laptop, personal computer, tablet, or the like. The live wallpaper displays imagery from various image sources, such as a web server storing photographs (e.g. Picasaweb, Panoramio, etc.), a social networking site (e.g. Google+, Facebook, Twitter), or other suitable image source. The live wallpaper displays new imagery and simultaneously queries an image source for images to be downloaded to the computing device upon the occurrence of various trigger conditions, such as upon user interaction with the live wallpaper or upon the passage of a period of time.

In a particular implementation, the live wallpaper can be configured to display geolocated photographs associated with a geographic area input into the computing device. The geographic area can be manually entered into the computing device, can be randomly generated, or can be based on the current location of the computing device as determined by a location monitoring component, such as a GPS module or circuitry configured to determine a device's location based on cellular signals. Upon the occurrence of a trigger condition, the computing device can download new geolocated photographs associated with the geographic area for display as the live wallpaper and the live wallpaper can be updated to display a new geolocated photograph associated with the geographic area. Optionally, geolocated photographs associated with a user's current location can be displayed and can change automatically as the user's locality changes.

In certain aspects, the live wallpaper can be configured to retrieve imagery that has not previously been displayed as the wallpaper on the computing device. For instance, upon the occurrence of a trigger condition, the computing device can query an image source for unseen images and download only unseen images to the computing device. One of the unseen images downloaded to the computing device can be selected for display as the live wallpaper. In this manner, the live wallpaper can be configured to continuously present new and unseen images to a user to provide a variety of different backgrounds for the user's computing device.

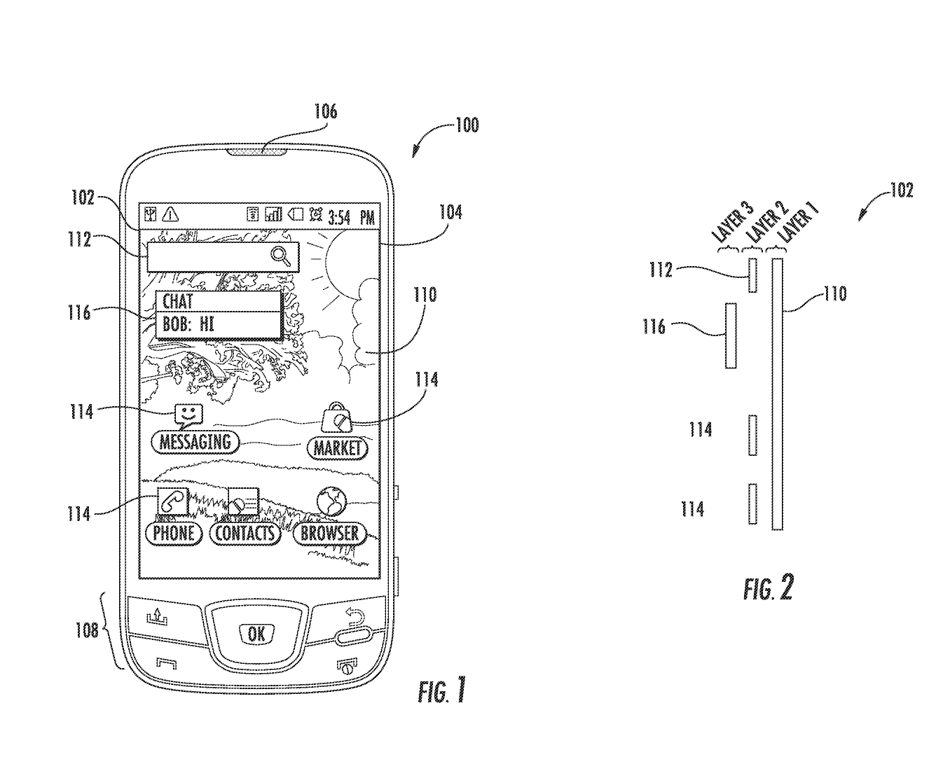

FIG. 1 depicts an exemplary computing device 100 having a graphical user interface 102 presented on a display 104. Although the computing device 100 depicted in FIG. 1 is a mobile device, the computing device 100 can take any appropriate form, such as a personal computer, smartphone, desktop, laptop, PDA, tablet or other computing device. The computing device 100 includes various input and output devices such as display 104 (e.g. touch screen), speakers 106, keys 108, etc. The computing device 100 includes a graphical user interface 102 presented on display 104 to allow user interaction with the computing device 100.

The graphical user interface 102 includes a wallpaper 110 that acts as the background for the graphical user interface 102. The wallpaper 110 depicted in FIG. 1 includes grass depicted under a sunny sky. As shown, the wallpaper 110 extends across substantially all of the display 104. A user can be allowed to select particular images for the wallpaper 110 so as to customize the computing device 100 in accordance with the user's personal tastes.

The wallpaper 110 can be a static image or can be a live wallpaper that responds to user interaction with the wallpaper 110. For instance, the blades of grass depicted in wallpaper 110 can be caused to move upon user interaction with the wallpaper 110, such as by a finger swipe across the blades of grass. Other examples of a live wallpaper include a wallpaper that changes periodically in response to a user input or other condition that causes a change in the appearance of the wallpaper.

Graphical user interface 102 further includes a search field 112 and a plurality of icons 114 arranged on top of the wallpaper 110. The search field 112 can be used to search the computing device 100 and/or the Internet for various files, documents, photos, emails, contacts, or other information. The icons 114 can be used to access various applications for computing device 100. For instance, the computing device 100 can include icons 114 that can be used to access telephone functionality, the user's contacts, a browser, a messaging service, a market for obtaining new applications, various games, social networks, etc. The graphical user interface 102 also includes an open chat application 116 that allows a user to send messages to a remote computing device 100. The search field 112, icons 114 and open application 116 can be moved in the graphical user interface 102 independently of the wallpaper 110.

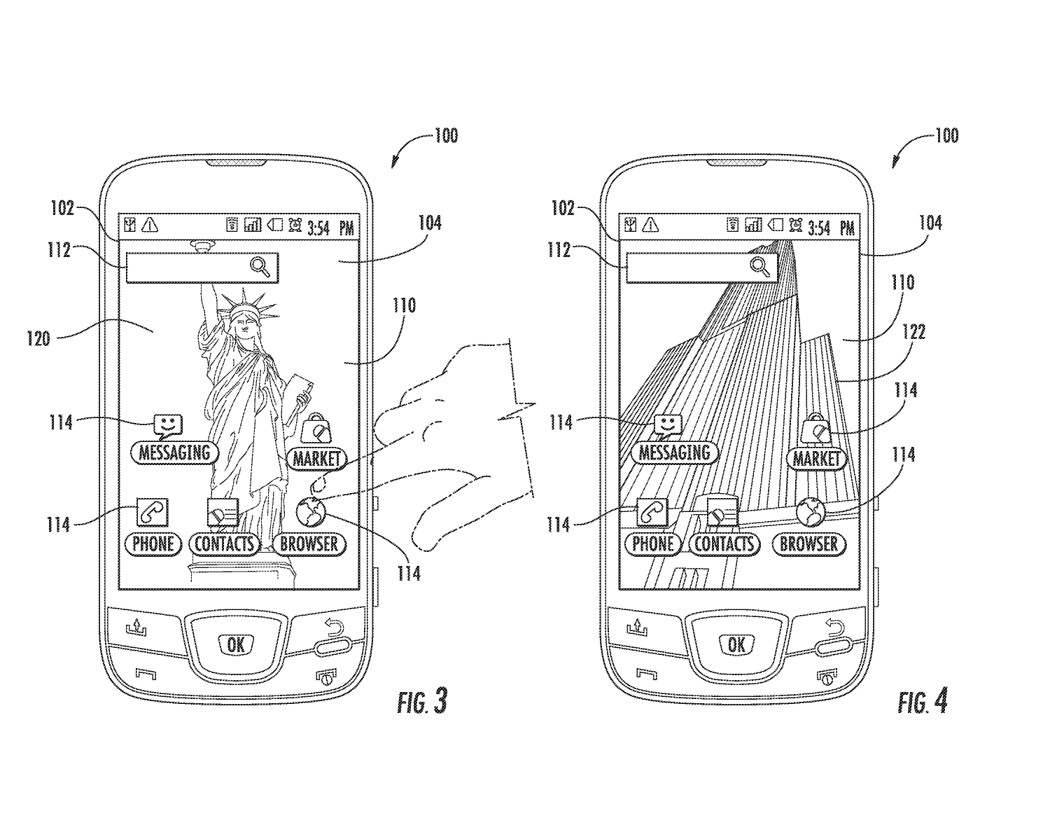

As shown in the conceptual side diagram of the graphical user interface 102 of FIG. 2, the search field 112 and the icons 114 are arranged on a visual layer on top of the wallpaper 110. The open chat application 116 is arranged on a visual layer on top of the layer associated with the icons 114. The layers depicted in FIG. 2 are not physically arranged as shown in FIG. 2. Rather, FIG. 2 illustrates the respective priority of the layers for display within the graphical user interface 102 on a display 104. In particular, when an element of the wallpaper 110 overlaps in the x-y dimension (in the plane of the display) with an icon 114 or search field 112, the icon 114 or search field 112 will receive priority for display so that it looks to the user like it is positioned closer to the user than the wallpaper 110.

The search field 112, icons 114 and open application 116 can be configured such that they completely hide the portion of the wallpaper 110 that is below or under the search field 112, icons 114, or open application 116. Alternatively, the search field 112, icons 114, and open application 116 can be partially transparent so that a portion of the wallpaper 110 beneath the search field 112, icons 114, or open application 116 is still displayed. In general, a user may be able to select whether all, some, or particular icons or other applications are displayed in a partially transparent manner or in a manner that completely obscures the wallpaper.

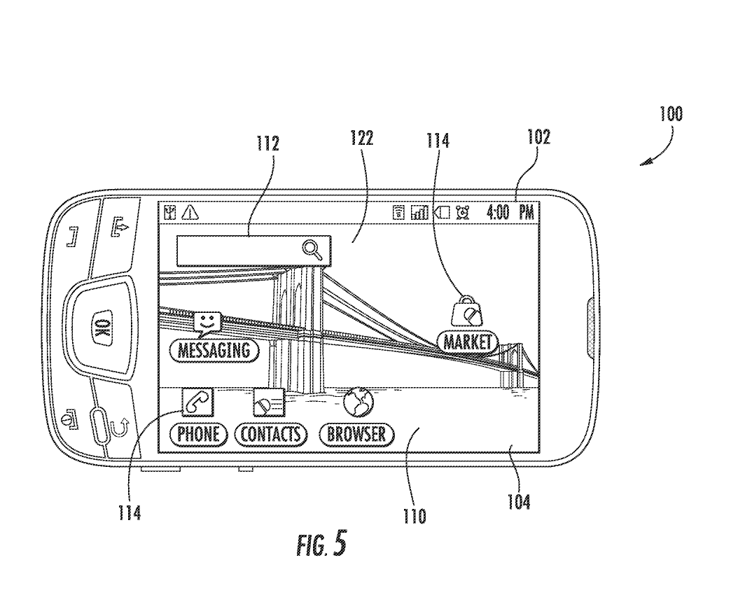

FIG. 3 depicts a computing device 100 displaying a live wallpaper 110 according to an exemplary aspect of the present disclosure. In particular, the live wallpaper 110 includes an image 120 received from one or more image sources over a network. While the graphical wallpaper 110 includes only a single image 120 that extends substantially across the display 104, those of ordinary skill in the art, using the disclosures provided herein, should understand that multiple images can be displayed as the wallpaper 110 without deviating from the scope of the present disclosure.

Upon the occurrence of a trigger condition, such as the finger swipe depicted in FIG. 3, the computing device 100 is configured to download an additional image or images from an image source. The wallpaper 110 is also updated to display a different image from the image source as the graphical wallpaper 110, such as the image 122 shown in FIG. 4. In particular aspects, the computing device 100 can be configured to download images that have not previously been displayed as wallpaper 110 upon the occurrence of the trigger condition. As will be discussed in detail below, available images from an image source can be compared to images already downloaded and/or displayed by the computing device 100 so that unseen images can be identified for display as wallpaper 110. In this manner, the live wallpaper 110 of the present disclosure can be configured to display a variety of fresh unseen images to a user and can allow a user to interact with the wallpaper 110 to display new images on demand.

The images displayed as wallpaper 110 can be received from a variety of image sources. For instance, in a particular embodiment, the computing device 100 can receive the image from a web server storing photographs or URLs associated with photographs, such as a web server associated with the Picasaweb and/or Panoramio image services provided by Google Inc. Other image sources could include a social networking site, such as Google+, Facebook, Twitter, etc. Any image source which exposes an API for retrieving images or URLs associated with images can act as an image source for wallpaper 110.

A user can select a particular image source or multiple image sources for wallpaper 110 by adjusting settings associated with the wallpaper 110. Certain image sources can be further subdivided according to user preferences. For instance, for imagery associated with Picasaweb, the user could have the option of sourcing from either geolocated photos, “featured photos,” a named Picasa user's public photos, or a named Picasa user's private photos provided that appropriate authentication is received.

The occurrence of a trigger condition causes the computing device 100 to download additional imagery from the image source and to display a different image or images as the wallpaper 110. The trigger condition can be a user interaction with the wallpaper 110, such as a finger swipe across the wallpaper 110. An additional trigger condition can be the passage of a specified amount of time. For instance, a user can access settings associated with the wallpaper 110 to specify that the wallpaper downloads and displays new imagery every five minutes, every hour, every day, etc. A trigger condition can also include a location change of sufficient magnitude by the computing device 100 as determined, for instance, by a location monitoring component associated with the computing device 100.

As shown in FIGS. 3-5, the wallpaper 110 can display images in either a portrait mode or a landscape mode depending on the orientation of the computing device 100. In a particular implementation, the wallpaper can be set to fit multiple desktop screens and can partially shift, with parallax, as the user shifts desktops left and right. For instance, as a user swipes the graphical user interface 102 to display additional desktop screens, the wallpaper 110 can shift partially under the new desktop screen.

A user can also have the option of disabling downloads of new imagery under certain circumstances to save battery power and/or network bandwidth. For instance, a user can restrict the download of additional images when a WiFi connection or high speed data connection (3G/4G) is not available. Settings associated with the wallpaper 110 could also allow the user to disable the downloading of additional images if a battery powering the computing device 100 is low.

According to a particular aspect of the present disclosure, the computing device 100 can be configured to download and display geolocated photographs as wallpaper 110. A geolocated photograph is a photograph that has associated data tying the photograph to a particular geographic location. Picasaweb and Panoramio are exemplary image sources that provide access to geolocated photographs.

The wallpaper 110 can be configured to display geolocated photographs associated with a particular geographic area input into the computing device 100. For instance, a user can request that the wallpaper 110 display geolocated photographs associated with a specific geographic area, e.g. New York, N.Y., or a randomly generated location on the globe. Alternatively, the user can request that the wallpaper 110 display geolocated photographs associated with the user's current location, as determined, for instance, by a location monitoring component associated with the computing device 100. Optionally, the wallpaper 110 can be configured to download additional geolocated photos from an image source and update the wallpaper to display a different geolocated photo upon a location change of sufficient magnitude by the computing device 100. In this manner, the wallpaper can change as the user's locality changes.

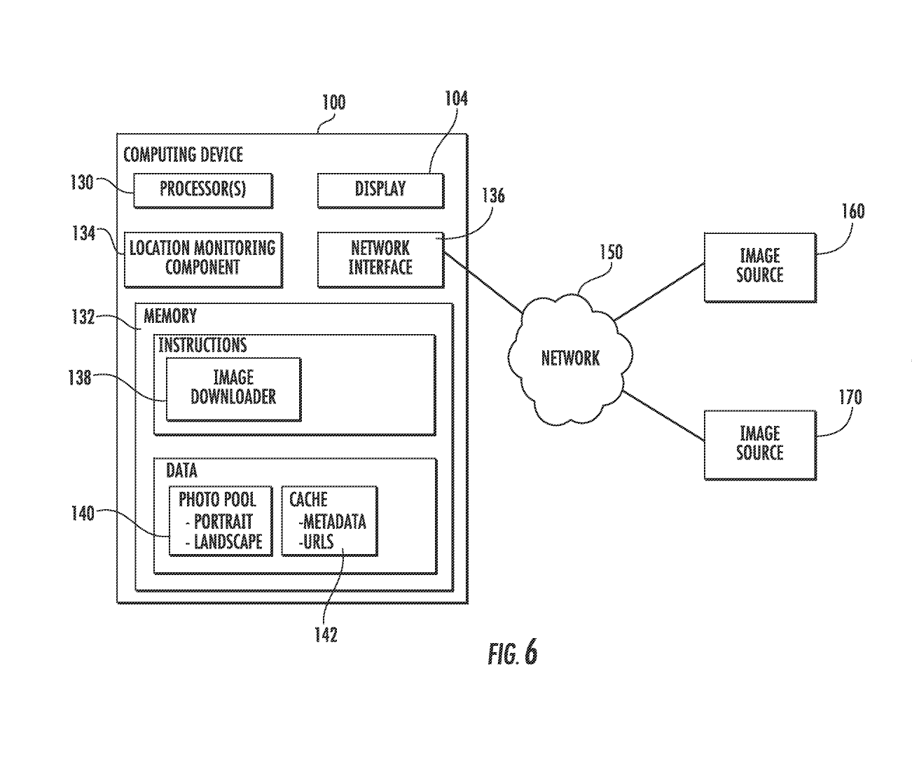

An exemplary live wallpaper 110 displaying geolocated photos is set forth in FIGS. 3-5. The wallpaper 110 of FIG. 3 depicts an exemplary geolocated photograph 120 associated with New York, N.Y. The exemplary geolocated photograph 120 depicted in FIG. 3 includes a picture of the Statue of Liberty. Upon the occurrence of a trigger condition, such as user interaction with the wallpaper 110, the passage of a specified amount of time, or a location change of sufficient magnitude, the wallpaper 110 is updated to display a different image, such as the geolocated photograph 122 of the Empire State Building depicted in FIG. 4. Upon the occurrence of yet an additional trigger condition, such as another location change of sufficient magnitude, the wallpaper 110 is updated to display another image, such as the geolocated photograph 124 depicting a portion of a bridge in New York, N.Y. shown in FIG. 5.

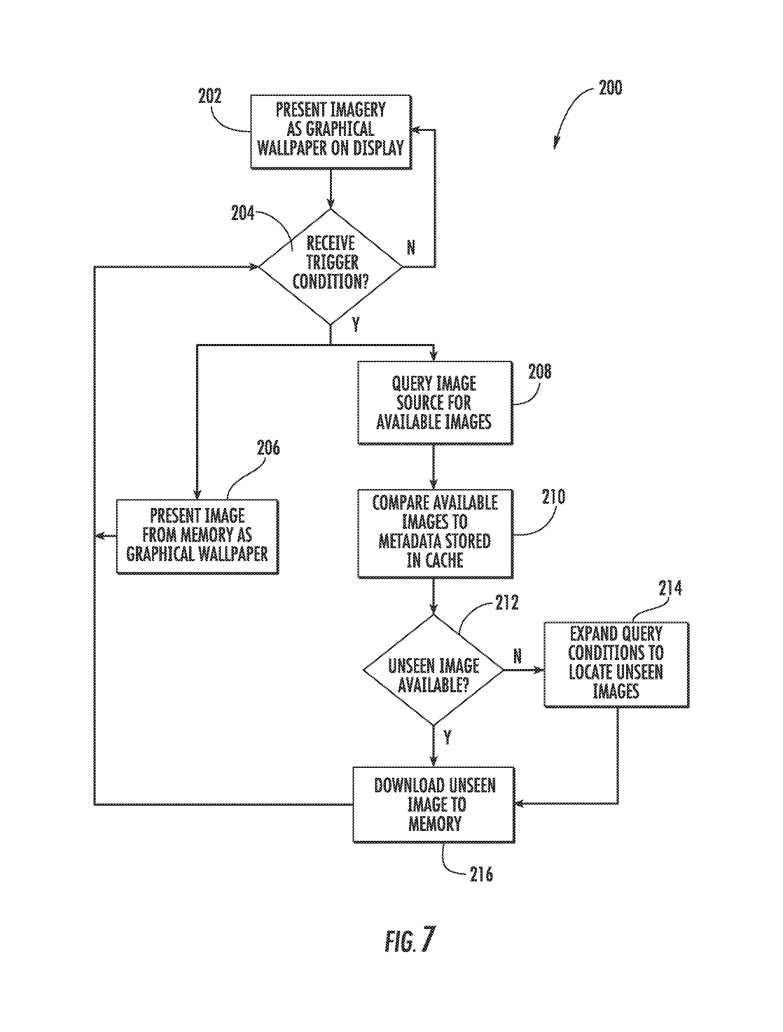

FIG. 6 provides a block diagram of exemplary architecture for implementing the live wallpaper according to exemplary aspects of the present disclosure. As previously discussed, computing device 100 includes a display 104 for displaying a graphical user interface, including the live wallpaper according to exemplary aspects of the present disclosure. Computing device 100 also includes a processor(s) 130 and a memory 132. The processor(s) 130 can be any known processing device. Memory 132 can include any suitable computer-readable medium or media, including, but not limited to, RAM, ROM, hard drives, flash drives, SD cards, or other memory devices.

Memory 132 stores information accessible by processor(s) 130, including instructions that can be executed by processor(s) 130. The instructions can be any set of instructions that when executed by the processor(s) 130, cause the processor(s) 130 to provide desired functionality. For instance, upon the occurrence of a trigger conditions, the instructions can cause the processor(s) 130 to execute an image downloader program to query an image source for unseen images for display as a wallpaper, download any unseen images to a memory location in the computing device 100, and display an image previously downloaded to the memory location as the wallpaper for a graphical user interface.

The instructions can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to application-specific circuits.

Memory 132 can also include data that may be retrieved, manipulated, or stored by processor(s) 130. For instance, memory 132 can include a photopool 140 containing data associated with images downloaded from an image source and stored in the memory 132 and a cache 142 that stores metadata associated with images previously downloaded or displayed from an image source.

The computing device 100 can include a network interface 136 for accessing information, such as images from image sources 160 and 170, over a network 150. The network 150 can include a combination of networks, such as cellular network, WiFi network, LAN, WAN, the Internet, and/or other suitable network and can include any number of wired or wireless communication links. For instance, computing device 100 could communicate through a cellular network using a WAP standard or other appropriate communication protocol. The cellular network could in turn communicate with the Internet, either directly or through another network.

Computing device 100 can also have a location monitoring component 134 for generating location information for the computing device 100. For instance, the computing device 100 can include a GPS module or can include a component for determining the position of the computing device 100 based on signals received from one or more cell phone towers. The computing device 100 can use the location information to query an image source, such as image sources 160 and 170, for geolocated photographs associated with the current location of the computing device 100. In addition, the computing device 100 can detect a location change of sufficient magnitude based on information from the location monitoring component 134 to trigger the download of additional imagery and the display of new imagery as the wallpaper on computing device 100.

As discussed above, image source 160 or 170 can be any source of imagery for display as wallpaper on the computing device 100. For instance, the image source 160 or 170 can be a web server storing photographs or URLs associated with photographs, such as a web server associated with Picasaweb, Panoramio, Google+, Facebook, Twitter, etc. The image source 160 or 170 typically exposes an API for retrieving images or URLs associated with images that can be used as a wallpaper on computing device 100. While two image sources 160 and 170 are illustrated in FIG. 6, more or less image sources can be accessed for receiving images for use as a wallpaper as desired.

Upon the occurrence of a trigger condition, the computing device 100 is configured to run background processes for receiving, resizing, and saving new images from an image source while the wallpaper is updated to display an image previously downloaded to the memory 132 of computing device 100. Because the download process happens in the background, there is no adverse effect on updating the wallpaper if downloading, resizing, or saving an image from an image source fails.

In particular, upon the occurrence of a trigger condition, the computing device 100 can send a query over network 150 to image source 160 to retrieve images or URLs associated with images. For instance, the computing device 100 can send an HTTP request or other suitable request to the image source. The query can specify parameters for images, such as image size, image type (e.g. geolocated photograph, “featured” photograph, etc.), the location of the computing device 100, user information, authentication information, etc.

The image source 160 locates images responsive to the query to provide to the computing device 100. In an exemplary implementation, only unseen images are requested from the image source 160. In particular, computing device 100 can maintain a cache 142 of metadata associated with previous images downloaded from an image source. For instance, the cache 142 of metadata can include information associated with the previous one hundred images downloaded to the computing device 100. The information stored in the cache 142 can be shared with the image source such that if the image source is queried multiple times with the same or similar settings, repeated images are not selected for delivery to computing device 100. Rather, the image source locates unseen images for delivery to the computing device 100.

Alternatively, the computing device 100 can accept or reject images specified by the image source 160 based on information stored in the cache 142. For instance, upon receiving information of available images from the image source 160, the computing device 100 can compare the available images with information stored in the cache 142 to determine if any unseen images are available. In this implementation, information stored in cache 142 does not have to be shared with image source 160 over network 150.

In yet another aspect, the cache 142 can be maintained at the image source 160 such that the image source 160 maintains a database of information optionally provided by a user of computing device 100. The information in cache 142 can be used to identify images previously downloaded by the computing device 100. The image source can use this information in selecting new images for delivery to computing device 100.

If the image source 160 cannot identify any unseen images responsive to the query, the image source can expand query conditions such that new unseen images become available. For instance, in the context of geolocated photographs, the area of interest set in the query can be expanded geographically to encompass additional geolocated photographs that have not yet been downloaded by the computing device 100. In the context of featured photographs, a new set of featured photographs can be specified if a user has already downloaded all of the featured photographs in a given set.

The image source 160 can send a response to the query specifying URLs of images responsive to the query. The response can be provided, for instance, in JSON format or any other suitable format. Upon receiving a suitable image URL from the image source 160, the URL is passed to the image downloader 138 to download the image.

The image downloader 138 attempts to retrieve the image at any specified URLs received from the image source 160. The image downloader 138 also resizes the downloaded image such that the image can fit the display 104 of the computing device 100. The resized information can then be saved in the memory 132 of the computing device 100. In a particular embodiment, the image downloader 138 can resize the image associated with a URL to two different sizes. One size can be suitable for display when the computing device 100 is in portrait mode and the other size can be suitable for display when the computing device 100 is in landscape mode. Both sizes are then saved in the memory 132 of the computing device 100 for presentation as the wallpaper on computing device 100. As discussed above, the download process can be run in the background after the occurrence of a trigger condition so there is no adverse effect on updating the wallpaper if downloading, resizing, or saving an image from an image source fails.

Once the image(s) has been successfully saved in the memory 132, the cache 142 is updated to reflect that the image has been downloaded by the computing device 100. In addition, information containing the path to the image file in the memory 132, image ownership data, and other metadata is stored in the photo pool 140.

The photo pool 140 contains a cache of currently downloaded and available images for display as wallpaper. In a particular embodiment, the photo pool 140 can be a least-recently-used cache, with a fixed size. For instance, the photo pool 140 can be configured to store data associated with twenty images. When a new image object is added to the photo pool 140 and the photo pool 140 is full, the oldest existing image object can be removed from the photo pool 140. The underlying image file(s) can also be removed from the memory 132 of the computing device 100, so the overall memory requirements of the live wallpaper remains static.

The photo pool 140 can also be configured to maintain an identifier of the next image to be displayed as wallpaper on the computing device 100. When a new image is to be displayed, the image associated with the next image identifier is presented as the wallpaper. The image identifier can move to the next image object stored in the photo pool 140, wrapping cyclically if the identifier comes to the end of image objects stored in the photo pool 140. When a new image object is added to the photo pool 140, the new image can be associated with the next image identifier such the newly downloaded image is always the next image to be displayed.

Upon the occurrence of a trigger condition, the computing device 100 queries the photo pool 140 for the next image to be displayed and loads the image from memory 132. The computing device 100 then displays the image as the wallpaper on the display 104. A transition animation can be used, such as wipe, when the existing image is replaced with the new image.

Additional information can be presented with the wallpaper as desired. For instance, the wallpaper can include the image owner and title as a small text annotation overlay. The wallpaper could also display a small logo indicating the image source, such as the Picasa logo, Panoramio logo, Google+logo, etc.

FIG. 7 provides a flow chart of an exemplary method 200 for displaying imagery as a wallpaper on a computing device according to an exemplary embodiment of the present disclosure. The method 200 is discussed with reference to a single computing device, such as computing device 100 depicted in FIG. 6. However, those of ordinary skill in the art should understand that the method steps discussed herein can be performed across many computing devices without deviating from the scope of the present disclosure.

At (202), imagery is presented as a graphical wallpaper on a display of a computing device. For instance, imagery, such as the geolocated photograph 120 depicted in FIG. 3, is presented as the wallpaper on the display of a computing device. At (204) the method determines whether it has received a trigger condition. A trigger condition can be user interaction with the wallpaper, the passage of a specified amount of time, or a location change of sufficient magnitude. If a trigger condition has not occurred, the method continues to present the current image as the wallpaper on the display of a computing device.

Upon the occurrence of a trigger condition, a new image stored in the memory of the computing device is presented as the wallpaper on the display of the computing device (206). Simultaneously with updating the wallpaper on the display device, the computing device queries an image source for available images (208). The query can specify parameters for the image source, such as type of image, image size, geographic location, etc. For instance, in the context of geolocated photographs, the query can specify a geographic location that has been input into the computing device. The geographic location can be based on a geographic location manually entered into the computing device, a randomly generated geographic location, or based on the current location of the computing device as determined by a location monitoring component.

The image source identifies images responsive to the query and shares information concerning the available images with the computing device. At (210), the computing device compares the information concerning available images with information stored in a cache in the memory of the computing device. The cache maintains information concerning images recently downloaded to the computing device.

Based on the information stored in the cache, the computing device determines whether any unseen images are available from the image source (212). If so, the computing device downloads the unseen image(s) to a memory at the computing device (216). If no unseen images are available, the query conditions can be expanded such that unseen images are available (214). For instance, in the context of geolocated photographs, the area of interest set in the query can be expanded geographically to encompass additional geolocated photographs that have not yet been downloaded by the computing device. In the context of featured photographs, a new set of featured photographs can be specified if a user has already downloaded all of the featured photographs in a given set. Once new imagery has been downloaded to the computing device, the method then waits for the occurrence of another trigger condition to cause the downloading and display of additional imagery as wallpaper.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method, comprising:
presenting a wallpaper for display, by one or more computing devices, the wallpaper displaying an image downloaded from an image source, the image being associated with a geographic area input into the one or more computing devices;
receiving a trigger condition at the one or more computing devices;
in response to the trigger condition, the method comprising:
determining, by the one or more computing devices, whether any unseen images associated with the geographic area are available for display from the image source;
downloading, by the one or more computing devices, an unseen image from the image source to a memory at the one or more computing device; and
while determining whether any unseen images associated with the geographic area are available for display from the image source, updating by the one or more computing devices, the wallpaper to display a new image associated with the geographic area on the display of the one or more computing devices, the new image being previously stored in a memory of the one or more computing devices prior to the occurrence of the trigger condition, the new image being different from the unseen image downloaded from the image source.

2. The computer-implemented method of claim 1, wherein the image comprises a geolocated photograph associated with the geographic area.

3. The computer-implemented method of claim I, wherein the geographic area is manually input in the computing device.

4. The computer-implemented method of claim 1, wherein the geographic area input into the computing device based on the current location of the computing device.

5. The computer-implemented method of claim 1, wherein the geographic area comprises a geographic area randomly selected by the computing device.

6. The computer-implemented method of claim 1, wherein the image source comprises a remote web server storing geolocated photos associated with the geographic area.

7. The computer-implemented method of claim 1, wherein receiving a trigger condition comprises receiving a user interaction with the one or more computing devices.

8. The computer-implemented method of claim 7, wherein the user interaction comprises dragging a finger across the display of the one or more computing devices.

9. The computer-implemented method of claim 1, wherein the trigger condition comprises the passage of a specified amount of time.

10. The computer-implemented method of claim 1, Wherein the trigger condition comprises a location change for the computing device of a specified magnitude.

11. The computer-implemented method of claim 1, wherein the method comprises storing, by the one or more computing devices, metadata associated with images downloaded from the image source at a memory on the one or more computing devices.

12. The computer-implemented method of claim 11, wherein determining, by the one or more computing devices, whether any unseen images associated with the geographic area are available for display from the image source comprises comparing, by the one or more computing devices, available images from the image source with the metadata associated with images previously downloaded from the image source stored in the memory at the one or more computing devices.

13. The computer-implemented method of claim 1, wherein determining, by the one or more computing devices, whether any unseen images associated with the geographic area are available from the image source comprises:
sending, by the one or more computing devices, a query to an image source requesting images associated with a geographic area input into the computing device;
determining, by the one or more computing devices, whether any unseen images are available responsive to the query; and
expanding, by the one or more computing devices, the geographic area specified in the query if no unseen images are available from the image source.

14. The computer-implemented method of claim 1, wherein downloading, by the one or more computing devices, an unseen image to a memory at the computing device comprises downloading, by the one or more computing devices, the unseen image to a memory comprising a plurality of downloaded images.

15. (canceled)

16. The computer-implemented method of claim 14, wherein. downloading, by the one or more computing devices, an unseen image to the memory comprises replacing, by the one or more computing devices, the oldest existing image stored in the memory with the unseen image.

17. The computer-implemented method of claim 1, Wherein the method comprises resizing, by the one or more computing devices, the downloaded image to a site associated with the site of a display device of the one or more computing devices.

18. The computer-implemented method of claim 17, wherein the method comprises:
resizing, by the one or more computing devices, the downloaded image to a first size suitable for display in portrait mode and to a second size suitable for display in landscape mode;
storing, by the one or more computing devices, an image associated with the first size and the second size in a memory of the computing device.

19. A computing device, comprising:
a display;
at least one memory;
a one or more processors, the one or more processors configured to execute instructions stored in the at least one memory to cause the computing device to perform operations, the operations comprising:
presenting a wallpaper on a display of the computing device, the wallpaper displaying an image downloaded from an image source, the image being associated with a geographic area input into the computing device;
receiving a trigger condition at the computing device; and
in response to the trigger condition, determining whether any unseen images associated with the geographic area are available for display from the image source; downloading an unseen image from the image source to a memory at the computing device; and while determining whether any unseen images associated with the geographical area are available for display from the image source, updating the wallpaper to display a new image on the display of the computing device, the new image being previously stored in at least one memory prior to the occurrence of the trigger condition, the new image being different from the unseen image downloaded from the image source.

20. The computing device of claim 19, wherein the image comprises a geolocated photograph associated with the geographic area.

21. (canceled)

22. The computing device of claim 19, wherein the image source comprises a remote web server storing geolocated photos associated with the geographic area.

23. The computing device of claim 19, wherein receiving a trigger condition comprises receiving a user interaction with the computing device.

24. The computing device of claim 23, wherein the user interaction comprises dragging a finger across the display of the computing device.

25. The computing device of claim 19, wherein the trigger condition comprises the passage of a specified amount of time.

26. The computing device of claim 19, wherein the trigger condition comprises a location change for the computing device of a specified magnitude.

27-35. (canceled)

36. One or more tangible, non-transitory computer readable media storing computer readable instructions that when executed by one or more processors cause the one or more processors to perform operations, the operations comprising:
presenting a wallpaper for display, by one or more computing devices, the wallpaper displaying an image downloaded from an image source, the image being associated with a geographic area input into the one or more computing devices;
receiving a trigger condition at the one or more computing devices;
in response to the trigger condition, the operations further comprise:
determining whether any unseen images associated with the geographic area are available for display from the image source;
downloading an unseen image from the image source to a memory at the one or more computing devices; and
while determining whether any unseen images associated with the geographical area are available for display from the image source, updating the wallpaper to display a new image associated with the geographic area on the display of the one or more computing devices, the new image being previously stored in a memory of the one or more computing devices prior to the occurrence of the trigger condition, the new image being different from the unseen image downloaded from the image source.
